(19) United States
(12) Patent Application Publication
(10) Pub. No.: US 2025/0331032 A1
(43) Pub. Date: Oct. 23, 2025

(54) SYSTEMS, METHODS, AND DEVICES FOR UL TIMING ADVANCE ACQUISITION AND UPDATE IN A WIRELESS COMMUNICATION NETWORK

(71) Applicant: Apple Inc., Cupertino, CA (US)

(72) Inventors: Hong He, San Jose, CA (US); Dawei Zhang, Saratoga, CA (US); Jie Cui, San Jose, CA (US); Weidong Yang, San Diego, CA (US); Wei Zeng, Saratoga, CA (US); Haitong Sun, Saratoga, CA (US); Huaning Niu, San Jose, CA (US); Chunhai Yao, Beijing (CN); Yushu Zhang, Beijing (CN); Chunxuan Ye, San Diego, CA (US)

(21) Appl. No.: 18/860,645

(22) PCT Filed: Apr. 29, 2022
(86) PCT No.: PCT/CN2022/090365

§ 371 Date: Oct. 26, 2024

(51) Int. Cl. H04W 74/0838; H04B 17/318; H04L 5/00; H04W 56/00; H04W 72/232

(52) U.S. Cl. CPC H04W 74/0838; H04B 17/328; H04L 5/0053; H04W 56/0045; H04W 72/232

(57) ABSTRACT

The techniques described herein include one or more solutions for enabling UEs to obtain initial uplink (UL) timing information (e.g., timing advance (TA) information) in a multi-transmission and reception point (TRP) scenario before a handover command and subsequent random access channel (RACH) procedure. A physical downlink (DL) control channel (PDCCH) order (e.g., downlink control information (DCI)) may be used to initiate a contention free random access (CFRA) procedure to obtain UL timing information for a non-serving TRP. The PDCCH order may be transmitted in a control resource set (CORESET) with a coresetPoolIndex value associated with a non-serving cell TRP. Several additional techniques and features are also described herein.

### FIELD

This disclosure relates to wireless communication networks including techniques for facilitating timing and synchronization in wireless communication networks.

### BACKGROUND

As the number of mobile devices within wireless networks, and the demand for mobile data traffic, continue to increase, changes are made to system requirements and architectures to better address current and anticipated demands. For example, some wireless communication networks may be developed to implement fifth generation (5G) or new radio (NR) technology, sixth generation (6G) technology, and so on. An aspect of such technology includes enabling base stations and user equipment (UE) to send and receive timing and synchronization information to help enable further wireless communications and perform wireless network procedures, such as establishing connections, engage in handover procedures, etc.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example network according to one or more implementations described herein.

FIG. 2 is a diagram of an example of uplink (UL) timing advance (TA) acquisition and update according to one or more implementations described herein.

FIG. 3 is a diagram of an example of search spaces associated with control resource sets (CORESETs) of different transmission and reception points (TRPs) according to one or more implementations described herein.

FIG. 4 is a diagram of an example process of a CFRA procedure initiated by a non-serving cell TRP according to one or more implementations described herein.

FIG. 5 is a diagram of an example process of a CFRA procedure initiated by a serving cell TRP according to one or more implementations described herein.

FIG. 6 is a diagram of an example of a current version of downlink control information (DCI) format 1_0 and an enhanced version of DCI format 1_0 according to one or more implementations described herein.

FIG. 7 is a diagram of an example table of an association between target cell ID (TCI) field values and physical cell IDs (PCIs) of non-serving cell TRPs according to one or more implementations described herein.

FIG. 8 is a diagram of an example process for a CFRA procedure initiated by a serving cell according to one of more implementations described herein.

FIG. 9 is a diagram of an example media access control (MAC) control element (CE) for an enhanced TCI state activation/deactivation for a non-serving cell CFRA procedure according to one of more implementations described herein.

FIG. 10 is a diagram of an example of a CFRA resource configuration per non-serving cell according to one of more implementations described herein.

FIG. 11 is a diagram of an example process for UE-autonomous conditional CFRA procedure with network-assist information according to one of more implementations described herein.

FIG. 12 is a diagram of an example of an enhanced MAC random access response (RAR) to indicate a non-serving cell TA value according to one or more implementations described herein.

FIG. 13 is a diagram of an example of multi-TRP communications and a corresponding differential TA value, according to one or more implementations described herein.

FIG. 14 is a diagram of examples of enhanced MAC CEs according to one or more of the implementations described herein.

FIG. 15 is a diagram of an example of search spaces associated with CORESETs of different TRPs according to one or more of the implementations described herein.

FIG. 16 is a diagram of an example of components of a device according to one or more implementations described herein.

FIG. 17 is a diagram of example interfaces of baseband circuitry according to one or more implementations described herein.

FIG. 18 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Telecommunication networks may include user equipment (UEs) capable of communicating with base stations and other network nodes. UEs and base stations may implement various techniques for establishing and maintaining connectivity, and for enabling UEs to move throughout the network by transitioning from one base station to another. A UE and base station may enable UE mobility by implement timing and synchronization operations, resource allocation procedures, random access channel (RACH) procedures, handover procedures, and more. These and other functions may enable UEs to efficiently communicate with, and move about, the network.

An aspiration of wireless technologies has been to enable ultra-reliable low latency communications (URLLC) between base stations and UEs. Examples of such technology may include enabling multiple input multiple output (MIMO) communications, mechanisms, and procedures for physical layer (e.g., layer 1 (L1)) and media access control (MAC) layer (e.g., layer 2 (L2)) based inter-cell mobility, performing handover and RACH procedures towards target transmission and reception points (TRPs), etc. A TRP, as described herein, may include a network node, such as a base station, capable of wireless communication with a UE. In some implementations, a base station may include an antenna array, processing capability, configuration, etc., such that the base station may be able to operate as multiple TRPs with respect to a UE.

While developed wireless technologies may enable UEs and base stations (e.g., TRPs) to engage in URLLC, MIMO, UE mobility, etc., to some extent, such technologies include several deficiencies. For example, current technologies regarding UE mobility may include a lengthy process of a UE measuring a signal strength of one or more base stations (e.g., a serving base station and one or more non-serving base stations) and sending a report of the measured signal strengths to a serving base station. The UE communicating with, or measuring, signals from multiple base stations may be referred to as a multi-TRP scenario, and based on the measurement report, the serving base station may determine whether to trigger a handover procedure. If so, the serving base station may send the UE a handover command via radio resource control (RRC) messaging, and in response, the UE may synchronize with a target base station, send a RACH preamble message to the target base station, receive a random access response (RAR) message in response, etc., to complete the procedure triggered by the handover command. During this handover, if the uplink (UL) transmissions of the UE are to be moved to a different (i.e., target) cell, the UE may need to obtain UL timing advance (TA) information of the target cell via the RACH procedure with the target cell as well. Such procedures may fail to optimize UE mobility within the network by, for example, causing the UE to synchronize with a target base station after receiving a handover command and performing a subsequent RACH procedure with the target base station. As such, UE mobility latency involved in transitioning from a serving base station to a target base station may be improved by enabling a UE to acquire a TA information for a non-serving base station before receiving a handover command, and thus minimizing mobility latency due to the RACH procedure. TA, as described herein, may include timing information used to control and/or synchronize UL signal transmission from a UE to a base station.

The techniques described herein may include one or more solutions for enhancing UE mobility within a wireless network by, for example, enabling the UE to obtain UL TA information regarding a target TRP (also referred to herein as a non-serving cell, target cell, non-serving TRP, target base station, non-serving base station, etc., before receiving a handover command and engaging in a subsequent RACH procedure with the target TRP. Doing so may enable the UE to transition from a serving base station to a non-serving base station, and obtain TA information for the non-serving base station, more quickly, and thereby increase the mobility of the UE within the wireless network. In turn, enhanced URLLC, MIMO, etc., may be facilitated.

One or more of the techniques described herein may involve using a physical downlink (DL) control channel (PDCCH) order (e.g., downlink control information (DCI) to initiate a random access (RA) procedure, including a contention free RACH (CFRA) procedure, to obtain UL timing information for a target or non-serving base station. The PDCCH order may be transmitted in a control resource set (CORESET) with a coresetPoolIndex value associated with a non-serving base station. One or more other techniques described herein may involve using a serving base station, and various signals/channels, to initiate a CFRA procedure toward a non-serving base station. One or more additional, or alternative, techniques described herein may involve a UE being explicitly configured by higher layers with timing and/or other information for TRPs (e.g., TRPs of a non-serving base station) that may have a physical cell ID (PCI) different from the serving base station. Additional or alternative techniques described herein may include operations and procedures for receiving RARs in inter-cell, multi-TRP scenarios, operations and procedures for maintaining UL time alignments for inter-cell multi-TRP scenarios, and more. These and other features of the techniques described herein are described below in detail with reference to the Figures that follow.

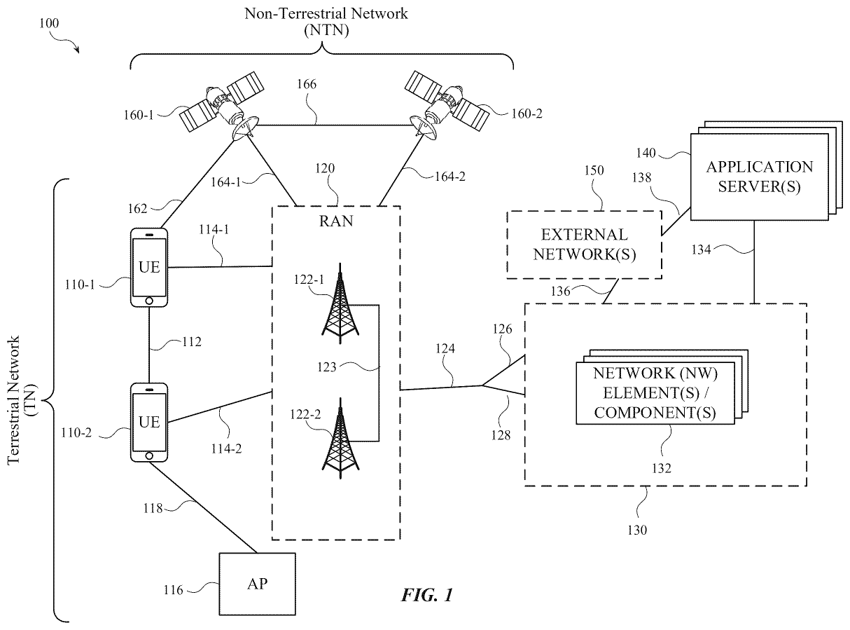

FIG. 1 is an example network 100 according to one or more implementations described herein. Example network 100 may include UEs 110-1, 110-2, etc. (referred to collectively as “UEs 110” and individually as “UE 110”), a radio access network (RAN) 120, a core network (CN) 130, application servers 140, external networks 150, and satellites 160-1, 160-2, etc. (referred to collectively as “satellites 160” and individually as “satellite 160”). As shown, network 100 may include a non-terrestrial network (NTN) comprising one or more satellites 160 (e.g., of a global navigation satellite system (GNSS)) in communication with UEs 110 and RAN 120.

The systems and devices of example network 100 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 100 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 110 may include smartphones (e.g., handheld touchscreen mobile computing devices connectable to one or more wireless communication networks). Additionally, or alternatively, UEs 110 may include other types of mobile or non-mobile computing devices capable of wireless communications, such as personal data assistants (PDAs), pagers, laptop computers, desktop computers, wireless handsets, etc. In some implementations, UEs 110 may include internet of things (IoT) devices (or IoT UEs) that may comprise a network access layer designed for low-power IoT applications utilizing short-lived UE connections. Additionally, or alternatively, an loT UE may utilize one or more types of technologies, such as machine-to-machine (M2M) communications or machine-type communications (MTC) (e.g., to exchanging data with an MTC server or other device via a public land mobile network (PLMN)), proximity-based service (ProSc), device-to-device (D2D) communications, or vehicle-to-everything (V2X) communications, sensor networks, IoT networks, and more. Depending on the scenario, an M2M or MTC exchange of data may be a machine-initiated exchange, and an loT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 110 may communicate and establish a connection with one or more other UEs 110 via one or more wireless channels 112, each of which may comprise a physical communications interface/layer. The connection may include an M2M connection, MTC connection, D2D connection, a V2X connection, etc. In some implementations, UEs 110 may be configured to discover one another, negotiate wireless resources between one another, and establish connections between one another, without intervention or communications involving RAN node 122 or another type of network node. In some implementations, discovery, authentication, resource negotiation, registration, etc., may involve communications with RAN node 122 or another type of network node.

UEs 110 may communicate and establish a connection with (e.g., bc communicatively coupled) with RAN 120, which may involve one or more wireless channels 114-1 and 114-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 122-1 and 122-2) that may be connected via non-ideal backhaul (e.g., where one network node provides NR access and the other network node provides cither E-UTRA for LTE or NR access for 5G). In such a scenario, one network node may operate as a master node (MN) and the other as the secondary node (SN). The MN and SN may be connected via a network interface, and at least the MN may be connected to the CN 130. Additionally, at least one of the MN or the SN may be operated with shared spectrum channel access, and functions specified for UE 110 can be used for an integrated access and backhaul mobile termination (IAB-MT). Similar for UE 101, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 122.

UEs 110 and base stations 122 may be configured to communicate with one another to perform on or more operations and/or procedures described herein. These communications may occur over one or more wireless channels 114-1 and 114-2. For example, UE 110 may comprise: one or more processors configured to: communicate, to a serving base station 122, a reference signal received power (RSRP) measurement on a non-serving cell corresponding to a non-serving base station 122; receive instructions to perform a CFRA procedure towards the non-serving base station; communicate, in response to the instructions and to the non-serving base station, a random access (RA) preamble message that is configured for the CFRA procedure associated with the non-serving cell of the non-serving base station; and receive, from the non-serving base station and in response to the RA preamble message, a random access response (RAR) message that includes TA information for communicating on the non-serving cell.

As shown, UE 110 may also, or alternatively, connect to access point (AP) 116 via connection interface 118, which may include an air interface enabling UE 110 to communicatively couple with AP 116. AP 116 may comprise a wireless local area network (WLAN), WLAN node, WLAN termination point, etc. The connection 1207 may comprise a local wireless connection, such as a connection consistent with any IEEE 702.11 protocol, and AP 116 may comprise a wireless fidelity (Wi-Fi®) router or other AP. While not explicitly depicted in FIG. 1, AP 116 may be connected to another network (e.g., the Internet) without connecting to RAN 120 or CN 130. In some scenarios, UE 110, RAN 120, and AP 116 may be configured to utilize LTE-WLAN aggregation (LWA) techniques or LTE WLAN radio level integration with IPsec tunnel (LWIP) techniques. LWA may involve UE 110 in RRC_CONNECTED being configured by RAN 120 to utilize radio resources of LTE and WLAN. LWIP may involve UE 110 using WLAN radio resources (e.g., connection interface 118) via IPsec protocol tunneling to authenticate and encrypt packets (e.g., Internet Protocol (IP) packets) communicated via connection interface 118. IPsec tunneling may include encapsulating the entirety of original IP packets and adding a new packet header, thereby protecting the original header of the IP packets.

RAN 120 may include one or more RAN nodes 122-1 and 122-2 (referred to collectively as RAN nodes 122, and individually as RAN node 122) that enable channels 114-1 and 114-2 to be established between UEs 110 and RAN 120. RAN nodes 122 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 122 may include a roadside unit (RSU), a transmission reception point (TRxP or TRP), and one or more other types of ground stations (e.g., terrestrial access points). In some scenarios, RAN node 122 may be a dedicated physical device, such as a macrocell base station, and/or a low power (LP) base station for providing femtocells, picocells or the like having smaller coverage areas, smaller user capacity, or higher bandwidth compared to macrocells. As described below, in some implementations, satellites 160 may operate as bases stations (e.g., RAN nodes 122) with respect to UEs 110. As such, references herein to a base station, RAN node 122, etc., may involve implementations where the base station, RAN node 122, etc., is a terrestrial network node and also to implementation where the base station, RAN node 122, etc., is a non-terrestrial network node (e.g., satellite 160).

Some or all of RAN nodes 122, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 122; a media access control (MAC)/physical (PHY) layer split wherein RRC, PDCP, radio link control (RLC), and MAC layers may be operated by the CRAN/vBBUP and the PHY layer may be operated by individual RAN nodes 122; or a “lower PHY” split wherein RRC, PDCP, RLC, MAC layers and upper portions of the PHY layer may be operated by the CRAN/vBBUP and lower portions of the PHY layer may be operated by individual RAN nodes 122. This virtualized framework may allow freed-up processor cores of RAN nodes 122 to perform or execute other virtualized applications.

In some implementations, an individual RAN node 122 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 120 or by a server pool (e.g., a group of servers configured to share resources) in a similar manner as the CRAN/vBBUP. Additionally, or alternatively, one or more of RAN nodes 122 may be next generation eNBs (i.e., gNBs) that may provide evolved universal terrestrial radio access (E-UTRA) user plane and control plane protocol terminations toward UEs 110, and that may be connected to a 5G core network (5GC) 130 via an NG interface.

Any of the RAN nodes 122 may terminate an air interface protocol and may be the first point of contact for UEs 110. In some implementations, any of the RAN nodes 122 may fulfill various logical functions for the RAN 120 including, but not limited to, radio network controller (RNC) functions such as radio bearer management, uplink and downlink dynamic radio resource management and data packet scheduling, and mobility management. UEs 110 may be configured to communicate using orthogonal frequency-division multiplexing (OFDM) communication signals with each other or with any of the RAN nodes 122 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 122 to UEs 110, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 122 may be configured to wirelessly communicate with UEs 110, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum may include channels that operate in the frequency range of approximately 400 MHz to approximately 3.8 GHz, whereas the unlicensed spectrum may include the 5 GHz band. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 110 and the RAN nodes 122 may operate using licensed assisted access (LAA), eLAA, and/or feLAA mechanisms. In these implementations, UEs 110 and the RAN nodes 122 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The LAA mechanisms may be built upon carrier aggregation (CA) technologies of LTE-Advanced systems. In CA, each aggregated carrier is referred to as a component carrier (CC). In some cases, individual CCs may have a different bandwidth than other CCs. In time division duplex (TDD) systems, the number of CCs as well as the bandwidths of each CC may be the same for DL and UL. CA also comprises individual serving cells to provide individual CCs. The coverage of the serving cells may differ, for example, because CCs on different frequency bands will experience different pathloss. A primary service cell or PCell may provide a primary component carrier (PCC) for both UL and DL and may handle RRC and non-access stratum (NAS) related activities. The other serving cells are referred to as SCells, and each SCell may provide an individual secondary component carrier (SCC) for both UL and DL. The SCCs may be added and removed as required, while changing the PCC may require UE 110 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe. To operate in the unlicensed spectrum, UEs 110 and the RAN nodes 122 may also operate using stand-alone unlicensed operation where the UE may be configured with a PCell, in addition to any SCells, in unlicensed spectrum.

The PDSCH may carry user data and higher layer signaling to UEs 110. The physical downlink control channel (PDCCH) may carry information about the transport format and resource allocations related to the PDSCH channel, among other things. The PDCCH may also inform UEs 110 about the transport format, resource allocation, and hybrid automatic repeat request (HARQ) information related to the uplink shared channel. Typically, downlink scheduling (e.g., assigning control and shared channel resource blocks to UE 110-2 within a cell) may be performed at any of the RAN nodes 122 based on channel quality information fed back from any of UEs 110. The downlink resource assignment information may be sent on the PDCCH used for (e.g., assigned to) each of UEs 110.

The PDCCH uses control channel elements (CCEs) to convey the control information, wherein a number of CCEs (e.g., 6 or the like) may consists of a resource element groups (REGs), where a REG is defined as a physical resource block (PRB) in an OFDM symbol. Before being mapped to resource clements, the PDCCH complex-valued symbols may first be organized into quadruplets, which may then be permuted using a sub-block interleaver for rate matching, for example. Each PDCCH may be transmitted using one or more of these CCEs, where each CCE may correspond to nine sets of four physical resource elements known as REGs. Four quadrature phase shift keying (QPSK) symbols may be mapped to each REG. The PDCCH may be transmitted using one or more CCEs, depending on the size of the DCI and the channel condition. There may be four or more different PDCCH formats defined in LTE with different numbers of CCEs (e.g., aggregation level, L=1, 2, 4, 8, or 16).

Some implementations may use concepts for resource allocation for control channel information that are an extension of the above-described concepts. For example, some implementations may utilize an extended (E)-PDCCH that uses PDSCH resources for control information transmission. The EPDCCH may be transmitted using one or more ECCEs. Similar to the above, each ECCE may correspond to nine sets of four physical resource elements known as an EREGs. An ECCE may have other numbers of EREGs in some situations.

The RAN nodes 122 may be configured to communicate with one another via interface 123. In implementations where the system is an LTE system, interface 123 may be an X2 interface. In NR systems, interface 123 may be an Xn interface. The X2 interface may be defined between two or more RAN nodes 122 (e.g., two or more eNBs/gNBs or a combination thereof) that connect to evolved packet core (EPC) or CN 130, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 110 from an SeNB for user data; information of PDCP PDUs that were not delivered to a UE 110; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 120 may be connected (e.g., communicatively coupled) to CN 130. CN 130 may comprise a plurality of network clements 132, which are configured to offer various data and telecommunications services to customers/subscribers (e.g., users of UEs 110) who are connected to the CN 130 via the RAN 120. In some implementations, CN 130 may include an evolved packet core (EPC), a 5G CN, and/or one or more additional or alternative types of CNs. The components of the CN 130 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 130 may be referred to as a network slice, and a logical instantiation of a portion of the CN 130 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 130, application servers 140, and external networks 150 may be connected to one another via interfaces 134, 136, and 138, which may include IP network interfaces. Application servers 140 may include one or more server devices or network elements (e.g., virtual network functions (VNFs) offering applications that use IP bearer resources with CM 130 (e.g., universal mobile telecommunications system packet services (UMTS PS) domain, LTE PS data services, etc.). Application servers 140 may also, or alternatively, be configured to support one or more communication services (e.g., voice over IP (VoIP sessions, push-to-talk (PTT) sessions, group communication sessions, social networking services, etc.) for UEs 110 via the CN 130. Similarly, external networks 150 may include one or more of a variety of networks, including the Internet, thereby providing the mobile communication network and UEs 110 of the network access to a variety of additional services, information, interconnectivity, and other network features.

As shown, example network 100 may include an NTN that may comprise one or more satellites 160-1 and 160-2 (collectively, “satellites 160”). Satellites 160 may be in communication with UEs 110 via service link or wireless interface 162 and/or RAN 120 via feeder links or wireless interfaces 164 (depicted individually as 164-1 and 164). In some implementations, satellite 160 may operate as a passive or transparent network relay node regarding communications between UE 110 and the terrestrial network (e.g., RAN 120). In some implementations, satellite 160 may operate as an active or regenerative network node such that satellite 160 may operate as a base station to UEs 110 (e.g., as a gNB of RAN 120) regarding communications between UE 110 and RAN 120. In some implementations, satellites 160 May communicate with one another via a direct wireless interface (e.g., 166) or an indirect wireless interface (e.g., via RAN 120 using interfaces 164-1 and 164-2).

Additionally, or alternatively, satellite 160 may include a GEO satellite, LEO satellite, or another type of satellite. Satellite 160 may also, or alternatively pertain to one or more satellite systems or architectures, such as a global navigation satellite system (GNSS), global positioning system (GPS), global navigation satellite system (GLONASS), BeiDou navigation satellite system (BDS), etc. In some implementations, satellites 160 may operate as bases stations (e.g., RAN nodes 122) with respect to UEs 110. As such, references herein to a base station, RAN node 122, etc., may involve implementations where the base station, RAN node 122, etc., is a terrestrial network node and implementation, where the base station, RAN node 122, etc., is a non-terrestrial network node (e.g., satellite 160). As described herein, UE 110 and base station 122 may communicate with one another, via interface 114, to enable enhanced power saving techniques.

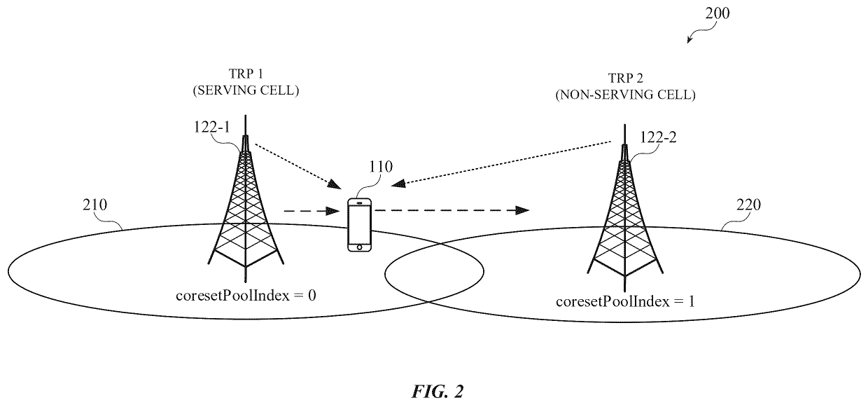

FIG. 2 is a diagram of an example 200 for UL TA acquisition and update according to one or more implementations described herein. As shown, FIG. 2 may include a serving base station 122-1 with a coverage area of a serving cell 210, UE 110 located within a coverage area of cell 210, and target base station 122-2 with a coverage area of non-serving cell 220. UE 110 may be moving in the direction of target base station 122-2. Base station 122-1 may have a PCI of 1 and may correspond to one COREST (e.g., with a coresetPoolInex parameter value of 0). Base station 122-2 may have a PCI of 2 and may correspond to a second COREST (e.g., with a corectPoolIndex parameter value of 1). Such a scenario may include a multi-TRP scenario with base station 122-1 corresponding to a first TRP (e.g., TRP 1) with respect to UE 110, and base station corresponding to a second TRP (e.g., TRP 2) with respect to UE 110.

The techniques described herein may include a variety of approaches for obtaining initial UL timing for multi-TRP scenarios. For example, UE 110 may be configured by higher layer communications with a set of CORESETs with different coresetPoolIndex values (e.g., a coresetPoolIndex value of 0 for base station 122-1 and a coresetPoolIndex value of 1 for base station 122-2). As such, FIG. 2 provides an example of CORESETs configured for inter-cell mTRP. In some implementations, UE capability information may be used to report a maximum number (X) of additional RRC-configured PCIs per frequency for obtaining and maintaining UL timing.

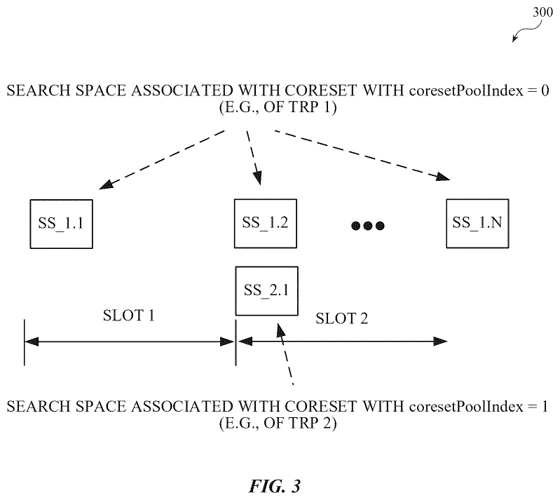

FIG. 3 is a diagram of an example 300 of search spaces associated with CORESETs of different TRPs according to one or more implementations described herein. Example 300 may correspond to example 200 of FIG. 2, where serving base station 122-1 corresponds to TRP 1 and target base station 122-2 corresponds to TRP 2. As shown, TRP 1 search spaces (SSs) with CORESETs (that include a coresetPoolIndex value of 0) may include search space SS_1.1 in a first slot, SS_1.2 in a second slot, . . . and so on until SS 1.N (where N is greater than or equal to 3). The second slot may also include SS_2.1 with a CORESET (that include a coresetPoolIndex value of 1) of TRP 2. As such, a random access procedure for obtaining UL timing for a TRP may be initiated by a PDCCH order (e.g., DCI format 1_0) transmitted in a CORESET with the coresetPoolIndex value associated with the non-serving cell TRP (e.g., a coresetPoolIndex of 1 of TRP 2). For example, the PDCCH order to trigger a CFRA procedure for TRP 2 may be transmitted by TRP 2 in the search space (SS) that is associated with a CORESET with a coresetPoolIndex of 1. As such, UE 110 may receive DCI that includes instructs for UE 110 to monitor a SS of a non-serving cell (e.g., base station 122-2).

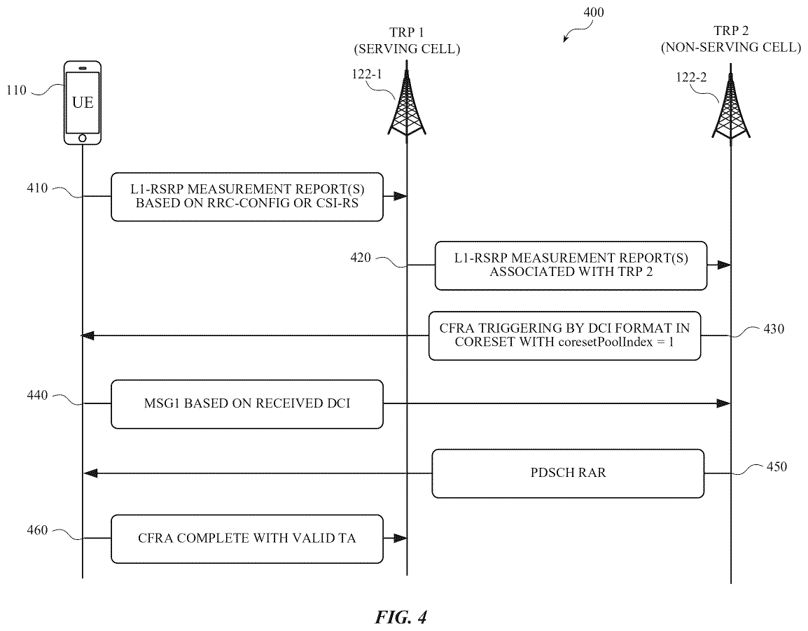

FIG. 4 is a diagram of an example process 400 of a CFRA procedure initiated by a non-serving cell TRP according to one or more implementations described herein. Processes 400 may be implemented by UE 110, base station 122-1, and base station 122-2. In some implementations, some or all of process 400 may be performed by one or more other systems or devices, including one or more of the devices of FIG. 1. Additionally, process 400 may include one or more fewer, additional, differently ordered and/or arranged operations than those shown in FIG. 4. In some implementations, some or all of the operations of process 400 may be performed independently, successively, simultaneously, etc., of one or more of the other operations of any of process 400.

As described above, UE 110 may receive configurations to measure an SSB corresponding to a non-serving cell (e.g., base station 122-2). As shown, UE 110 may communicate reports, based on the SSB, of L1 reference signal received power (RSRP) measurements to base station 122-1 (e.g., TRP 1) (at 410). Additionally, the RSRP measurements and/or RSRP measurement reports may be based on RRC configuration information and/or channel status information (CSI) reference signal (RS) (CSI-RS) that UE 110 may have previously received from base station 122-1 or base station 122-2. Base station 122-1 may send the L1-RSRP measurement reports associated with TRP 2 to base station 122-2 (at 420).

Base station 122-2 may respond to the reports by sending DCI, to UE 110, to trigger a CFRA procedure (at 430). The DCI may be of DCI format 1_0 and may be transmitted in a CORESET with a coresetPoolIndex value of 1, which may be a coresetPoolIndex value corresponding to TRP 2. UE 110 may respond by sending a CFRA message 1 (MSG1) to base station 122-2 based on the DCI (at 440). Base station 122-2 may receive the MSG1 and respond with a PDSCH RAR message (at 450), and UE 110 may respond by sending a CFRA complete message to base station 122-1 (at 460) to notify the completion of the CFRA procedure towards the TRP 2. As shown, the CFRA complete message may include a valid TA of base station 122-2, which may help facilitate a subsequent L1/L2-based handover to base station 122-2.

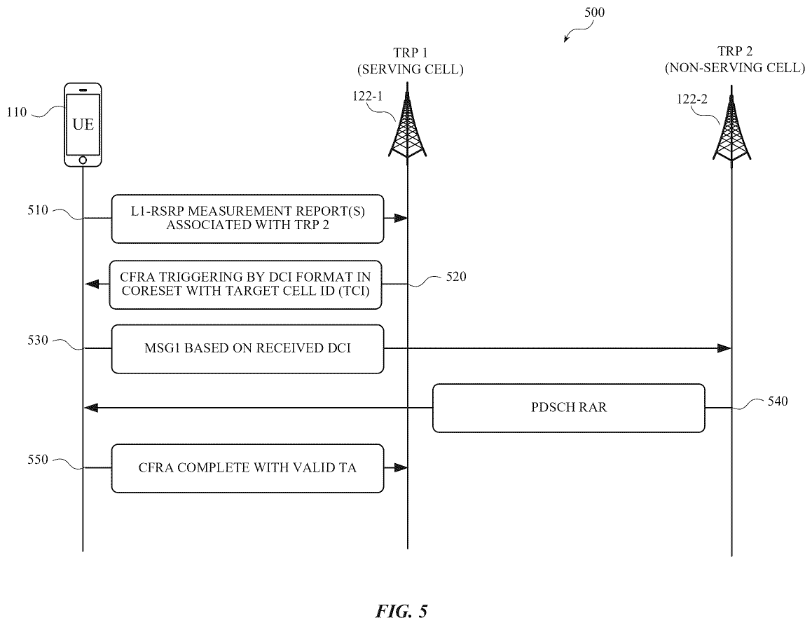

FIG. 5 is a diagram of an example process 500 of a CFRA procedure initiated by a serving cell TRP according to one or more implementations described herein. Processes 500 may be implemented by UE 110, base station 122-1, and base station 122-2. In some implementations, some or all of process 500 may be performed by one or more other systems or devices, including one or more of the devices of FIG. 1. Additionally, process 500 may include one or more fewer, additional, differently ordered and/or arranged operations than those shown in FIG. 5. In some implementations, some or all of the operations of process 500 may be performed independently, successively, simultaneously, etc., of one or more of the other operations of any of process 500.

As described above, UE 110 may receive configuration to measure an SSB corresponding to a non-serving cell TRP 2 (e.g., base station 122-2). UE 110 may communicate reports, based on the SSB, of L1 RSRP measurements to base station 122-1 (e.g., TRP 1) (at 510). Additionally, the RSRP measurements and/or RSRP measurement reports may be based on RRC configuration information and/or CSI-RS) that UE 110 may have previously received from base station 122-1 or base station 122-2.

Base station 122-1 may respond to the RSRP measurements by sending DCI, to UE 110, to trigger a CFRA procedure toward base station 122-2 (at 520). The DCI may be of DCI format 1_0, transmitted in a CORESET (e.g., coresetPoolIndex 0), and may include information identifying base station 122-2, such as a target cell ID (TCI) of base station 122-2. UE 110 may respond by sending a CFRA MSG1 to base station 122-2 based on the DCI (at 530). Base station 122-2 may receive the MSG1 and respond with a PDSCH RAR message (at 540), and UE 110 may respond by sending a CFRA complete message to base station 122-1 (at 550). As shown, the CFRA complete message may include a valid TA of base station 122-2, which may help facilitate a subsequent L1/L2-based handover to base station 122-2.

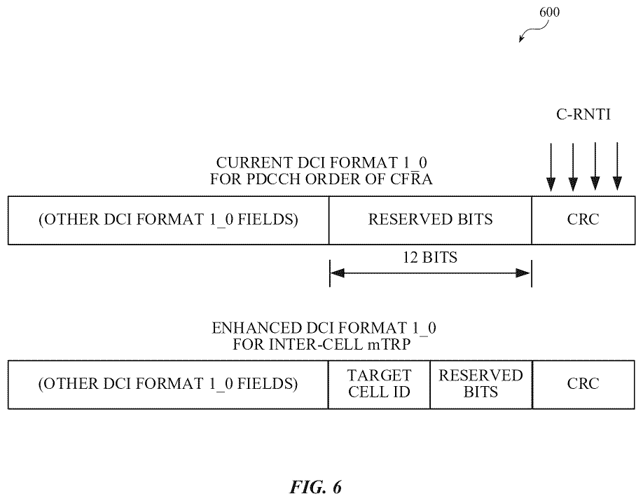

FIG. 6 is a diagram of an example 600 of a current version of DCI format 1_0 and an enhanced version of DCI format 1_0 according to one or more implementations described herein. As shown, the current version of DCI format 1_0 may be used for PDCCH order of CFRA of the serving cell only and may include a cyclic redundancy check (CRC) field (which may be scrambled by a cell radio network temporary identifier (C-RNTI)), 12 reserved bits, and other DCI format 1_0 fields). The enhanced version of DCI format 1_0 may be for inter-cell multi-TRP (mTRP) procedures and may include a CRC field and other DCI format 1_0 fields. In contrast to the current version, the enhanced DCI format 1_0 may also include a TCI field by repurposing a portion of reserved bits and a small leftover portion of reserved bits relative to the larger portion of reserved bits of the current DCI format 1_0. The enhanced DCI format 1_0 may be used by a serving cell TRP (e.g., base station 122-1) to trigger UE 110 to perform a CFRA procedure toward a target or non-serving cell TRP (e.g., base station 122-2). In some implementations, a PCI of the target non-serving cell may be explicitly indicated by the TCI field. In such implementations, the TCI field size may be larger (e.g., up to 12 bits) than depicted in FIG. 6 as the PCI may be up to 1008.

In some implementations, additional or alternative signaling mechanisms may be used by a serving cell TRP (e.g., base station 122-1) to trigger UE 110 to perform a CFRA procedure toward a target or non-serving cell TRP (e.g., base station 122-2). For example, a combination of RRC signaling and DCI may be used. In such an implementation, new RRC message may be used to provide a dedicated TCI field value for a given non-serving cell in list. Such an RRC message may include an ASN.1 (abstract syntax notation.1) structure in accordance with, or similar to, the following.

```
InterCellCFRAList ::= SEQUENCE (Size (1::maxNrOfInterCells)) of InterCellCFRA;
InterCellCFRA ::= SEQUENCE {
  TargetCellId ServCellIndex,
  TCI-InSchedulingCell INTEGER (1..7)}
```

In such implementations, the TCI-InSchedulingCell field may indicate a TCI value used in the serving cell TRP (e.g., base station 122-1) to trigger a CFRA procedure involving a non-serving cell TRP (e.g., base station 122-2) indicated with the TargetCellId field. The corresponding TCI field value associated with the non-serving cell TRP may be included in the enhanced DCI format 1_0. In some implementations, the TCI field size may be 3-bits. Alternatively, the TCI field size may depend on a total number of non-serving cell TRPs that are configured with CFRA capability. In some implementations, a particular field value (e.g., all zeros or all ones) maybe reserved to trigger CFRA for the serving cell itself.

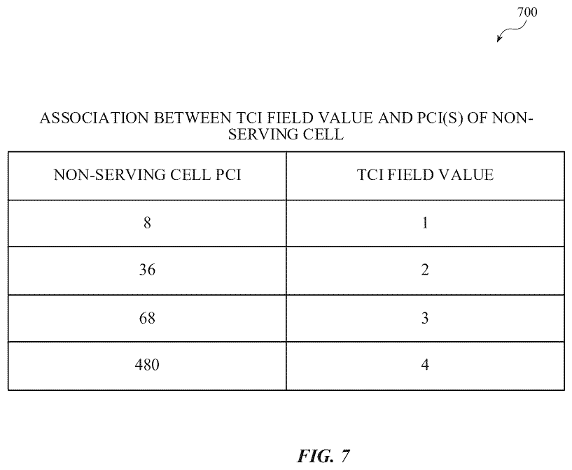

FIG. 7 is a diagram of an example table 700 of an association between TCI field values and PCIs of non-serving cell TRPs according to one or more implementations described herein. As shown, a non-serving cell PCI of 8 may be associated with a TCI field value of 1. A non-serving cell PCI of 36 may be associated with a TCI field value of 2. A non-serving cell PCI of 68 may be associated with a TCI field value of 3. And a non-serving cell PCI of 480 may be associated with a TCI field value of 4. As such, a serving cell TRP (e.g., base station 122-1) may send information associated TCI field values with PCIs of non-serving cell TRPs (e.g., base station 122-2). The serving cell may also send an RRC message (e.g., using ASN.1 structure) to indicate a TCI value that UE 110 may use to identify the PCI of the non-serving cell TRP with which to initiate a CFRA.

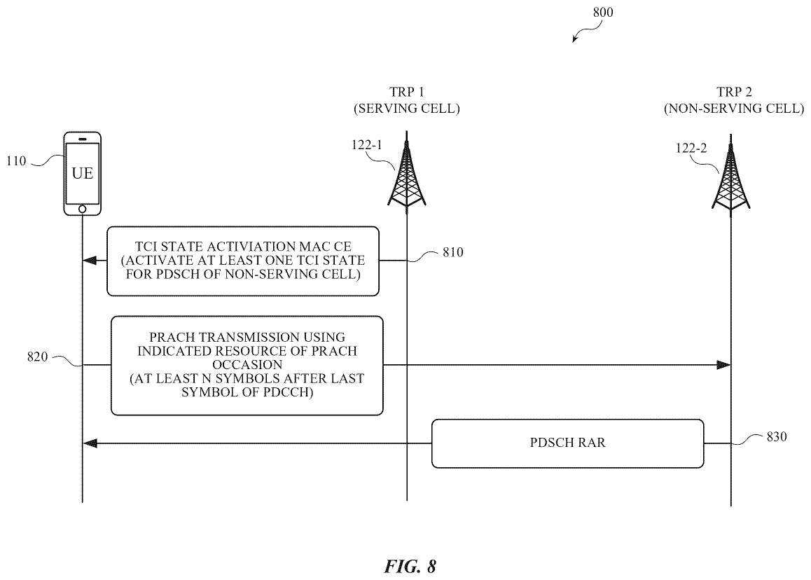

FIG. 8 is a diagram of an example process 800 for CFRA initiated by a serving cell according to one of more implementations described herein. Processes 800 may be implemented by UE 110, base station 122-1, and base station 122-2. In some implementations, some or all of process 800 may be performed by one or more other systems or devices, including one or more of the devices of FIG. 1. Additionally, process 800 may include one or more fewer, additional, differently ordered and/or arranged operations than those shown in FIG. 8. In some implementations, some or all of the operations of process 800 may be performed independently, successively, simultaneously, etc., of one or more of the other operations of any of process 800.

As shown, base station 122-1 may send a transmission configuration indicator state activation MAC control element (CE) message to UE 110 (at 810). The transmission configuration indicator state activation MAC CE message may be configured to identify a non-serving cell (via an identifier (i) in the message and/or indicate resources of a PRACH occasion that UE 110 may use to contact the non-serving cell (e.g., base station 122-2). The PRACH occasion may be at least a specified number of symbols (N) after a last symbol of a PDCCH order reception. The specified number of symbols may, for example, be configured by a communication standard such that the number of symbols is common among all, or similarly capable and/or situated, UEs 110. Accordingly, UE 110 may proceed by sending a PRACH transmission to the non-serving cell (e.g., base station 122-2) (at 820). UE 110 may send the PRACH transmission using PRACH occasion resources indicated in the TCI state activation MAC CE message. Base station 122-2 may receive the PRACH transmission and respond by sending UE 110 a PDSCH RAR message (at 830). The PDSCH RAR message may include, for example, TA information that UE 110 may use the TA information in subsequent communications to help reduce mobility latency.

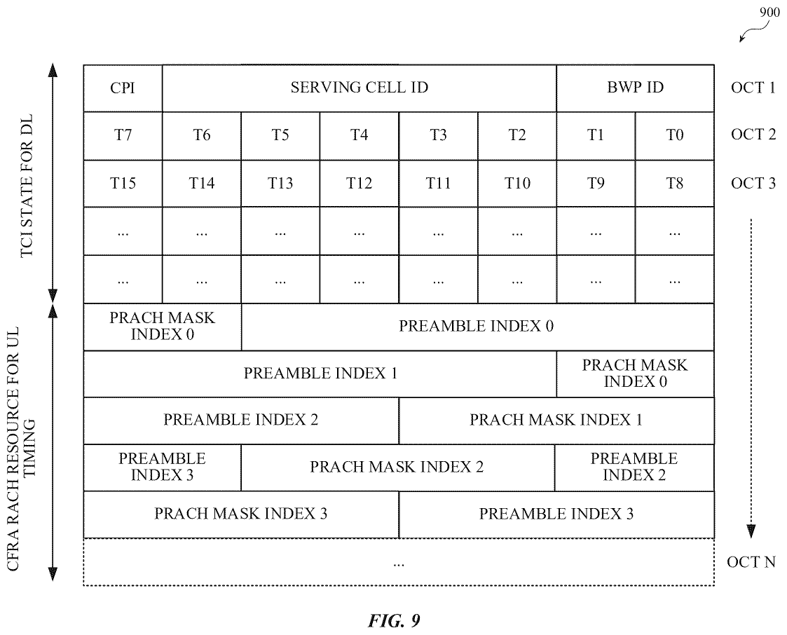

FIG. 9 is a diagram of an example MAC CE 900 for an enhanced TCI state activation/deactivation for a non-serving cell CFRA procedure according to one or more implementations described herein. As shown, MAC CE 900 may include information arranged horizontally in bit octets (e.g., Oct 1, Oct 2, Oct 3, . . . , Oct N) with each octet being vertically adjacent to one or two other octets. MAC CE may include a TCI state for DL portion, which may include a first octet (e.g., Oct 1) with a two-bit BWP ID field, six-bit serving cell ID field, and one-bit CPI (coresetPoolIndex) field. Oct 2 and Oct 3 may include TCI indexed fields T0-T7 and TCI T8-T15, respectively. MAC CE 900 may also include a CFRA RACH resources portion for UL timing, which may include fields for physical random access channel (PRACH) mask indexes 0-3 and fields for preamble indexes 0-3. TCI index 0 may correspond to the PRACH mask index 0 and preamble index 0, TCI index 1 may correspond to the PRACH mask index 0 and preamble index 1, and so on.

In accordance with MAC CE 900, a PRACH resource may be used for a CFRA operations when explicitly indicated by an enhanced TCI states activation MAC-CE, such as MAC-CE 900. A preamble index (i) and a PRACH mask index (i) pair may only be present when TCI-states activation MAC CE is applied to a non-serving cell TRP (e.g., base station 122-2). That is, the pair may be mapped based on an ordinal position among TCI states with a value set 1 to minimize the overhead. In other words, for example, the pair (preamble index #0 and PRACH mask index #0) may be mapped to a first TCI state with value set to 1, second (preamble index #1, PRACH mask index #1) may be mapped to a second TCI state with value set to 1, and so on.

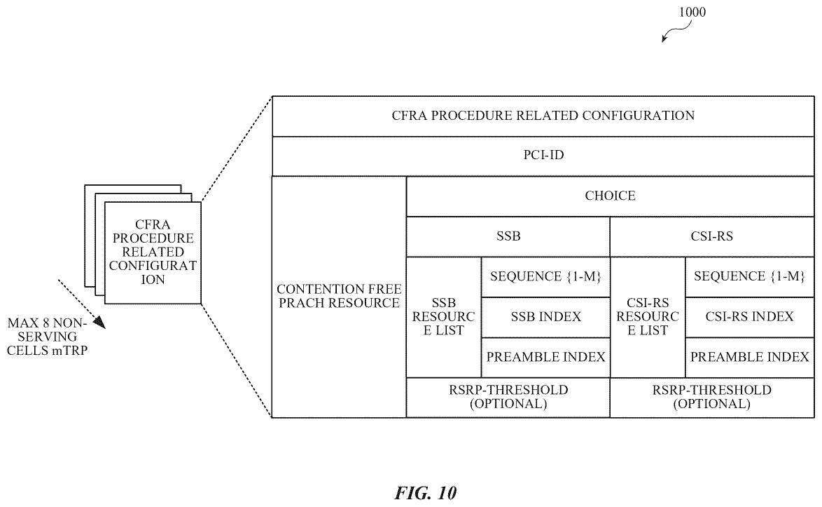

FIG. 10 is a diagram of an example of a CFRA resource configuration 1000 per non-serving cell according to one of more implementations described herein. As shown, in some implementations, there may be one or more CFRA resource configurations 1000 (possibly to a maximum of 8). CFRA resource configuration 1000 may include a PCI-ID field, a contention frec PRACH resources field, a choice field, an SSB field, an SSB resource list field with a Sequence {1 to M} field, an SSB index field, and a preamble index field, a CSI-RS field, and a CSI-RS resources list field with a Sequence {1 to M} field, a CS-RS index field, and a preamble index field. CFRA resource configuration 1000 may also include an rsrp-ThresholdSSB field (which may be optional) and an rsrp-ThresholdCS-RS field (which may be optional).

The techniques described herein may include an RRC-MAC-CE signaling approach to random access (e.g., CFRA) initialization for inter-cell multi-TRP. The PRACH resources used for the CFRA operation maybe provided by RRC signaling to be associated with a SSB index or a CSI-RS index of each non-serving cell. CFRA resource configuration 1000 may be an example of such a data structure.

Upon receiving a TCI state activation MAC-CE that activates at least one TCI state for PDSCH of a non-serving cell (i), a UE 110 may transmit a PRACH by using the corresponding RACH resource associated with the SSBs or CSI-RSs (e.g., as represented by CFRA resource configuration 1000). In some implementations, when more than one TCI-states of the non-severing cell are activated by the a single TCI-state MAC CE, UE 110 may select an SSB or CSI-RS with the largest L1-RSRP to perform the CFRA procedure. Alternatively, UE 110 may perform CFRA for all activated TCI-states in a time division multiplexing (TDM) manner and the order of CFRA for different TCI-states may depend on a configuration of UE 110.

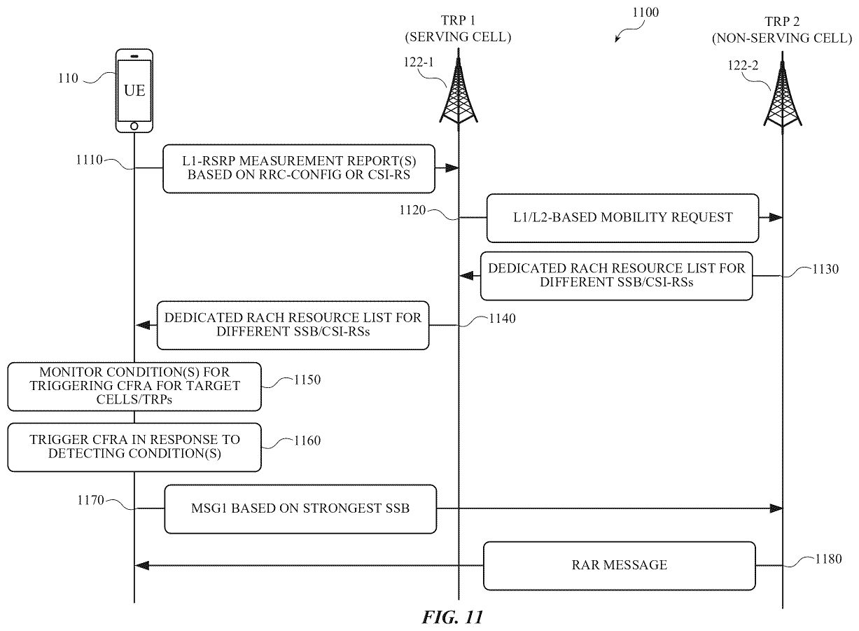

FIG. 11 is a diagram of an example process 1100 for UE-autonomous conditional CFRA procedure with network-assist information according to one of more implementations described herein. Processes 1100 may be implemented by UE 110, base station 122-1, and base station 122-2. In some implementations, some or all of process 1100 may be performed by one or more other systems or devices, including one or more of the devices of FIG. 1. Additionally, process 1100 may include one or more fewer, additional, differently ordered and/or arranged operations than those shown in FIG. 11. In some implementations, some or all of the operations of process 1100 may be performed independently, successively, simultaneously, etc., of one or more of the other operations of any of process 1100.

In some implementations, UE 110 may be explicitly configured (e.g., by higher layers) with information for each TRP that has a PCI different from the serving cell (e.g., base station 122-1). As shown, UE 110 may send L1-RSRP measurement reports based on RRC configured SSB or CSI-RS transmissions (at 1110). Base station 122-1 may receive the measurements and may send a L1/L2-based mobility request to base station 122-2 based on the measurements (at 1120). Base station 122-2 may respond by sending, to base station 122-1, a dedicated PRACH resources list for different SSB/CSI-RSs (at 1130), which base station 122-1 may send to UE 110 (at 1140). A dedicated PRACH resource for an inter-cell mTRP may be provided in a way that enables UE 110 to associate the dedicated PRACH resource to an SSB index or a CSI-RS index. Additionally, or alternatively, a rsrp-ThresholdSSB or rsrp-ThresholdCSI-RS maybe also provided, which may be used by UE 110 to determine whether to initiate a UE-autonomous RACH procedure based on an SSB or CSI-RS RSRP measurement.

UE 110 may use the resources list to monitor one or more conditions that may trigger a CFRA procedure to target cells or TRPs, such as base station 122-2 (at 1150). Such a condition may be, for example, whether an SSB or CSI-RS RSRP measurement exceeds a threshold indicated by information received from base station 122-2 (e.g., rsrp-ThresholdSSB or rsrp-ThresholdCSI-RS).

In some implementations, UE 110 may be explicitly configured via higher layer communications, which may include a configuration of Type1-PDCCH common search space (CSS) set for RAR reception, including DL BWP information. In some implementations, a same configuration of Type1-PDCCH CSS set and DL BWP as serving cell (e.g., base station 122-1) may be assumed by UE 110 if it is not provided for a non-serving cell. With pre-configured information (e.g., received via higher levels), UE 110 may have dedicated PRACH resources stored for mTRPs of multiple cells, which may reduce the handover time when a failure is detected (e.g., because UE 110 may transition to another target cell more quickly due to the information stored for multiple cells). As shown in FIG. 5, UE 110 may start evaluating for CFRA trigger conditions based on the measured L1-RSRP for RRC-configured SSB or CSI-RS (at 1150) and trigger CFRA using the RRC-configured RACH resource once condition is met (at 1160). For purposes of explaining example process 1100, assume that UE 110 detects one or more of the conditions and responds by triggering a CFRA (at 1160). UE 110 may proceed by sending a RACH MSG1 to base station 122-2 based on a strongest SSB. Base station 122-2 may respond to the MSG1 by sending UE 110 an RAR message (at 1180).

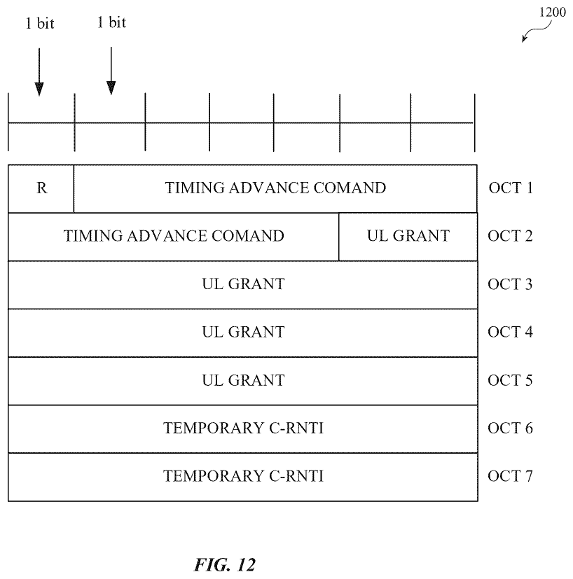

FIG. 12 is a diagram of an example of an enhanced MAC RAR 1200 to indicate a non-serving cell TA value according to one or more implementations described herein. As enhanced MAC RAR 1200 may include seven rows of bit octets (oct 1, oct, oct 3, and so on). A first octet (oct 1) may include one repurposed bit (R) and 7 bits for TA command information. Bit R may indicate a coresetPoolIndex value (e.g., 0 or 1). As described herein, a coresetPoolIndex value of 0 may correspond to a serving cell TRP (e.g., base station 110-1) and a coresetPoolIndex value of 1 may correspond to a serving cell TRP (e.g., base station 110-2). Octet 2 may include 6 more bits for the TA command information and 2 bits for UL grant information. Octets 3-5 may also be used for UL grant information, and octets 6 and 7 may be for a temporary C-RNTI information.

UE 110 may monitor a Type1-PDCCH CSS set, of a non-serving cell TRP (e.g., base station 122-2), for a DCI format 1_0, which may include CRC scrambled with C-RNTI or RA RNTI (RA-RNTI), during a RAR window. In some implementations, a serving cell (e.g., base station 122-1) may provide UE 110 with an explicit indication of a configuration of the Type 1-PDCCH CSS set associated with the non-serving cell (e.g., base station 122-2). The explicit indication may be through RRC messaging before a CFRA is triggered. In some implementations, a serving cell (e.g., base station 122-1) may provide UE 110 with the configuration implicitly (e.g., as UE 110 may be configured to apply a Type1-PDCCH CSS set associated with the serving cell to the non-serving cell.

UE 110 may also, or alternatively, a Type1-PDCCH CSS set, of a serving cell TRP (e.g., base station 122-1), for a DCI format 1_0, which may include CRC scrambled with C-RNTI or RA-RNTI, during a RAR window. In some implementations, this may be facilitated by a backhaul network enabling base stations 122-1 and 122-2 to communicate such that base station 122-1 may, for example, provide UE 110 with a RAR message that would have otherwise come from base station 122-2. In such implementations, enhanced MAC RAR 1200 of FIG. 12 may be used as repurposed bit (R) may be changed to indicate an appropriate coresetPoolIndex valuc (e.g., a value of 1 for base station 122-2).

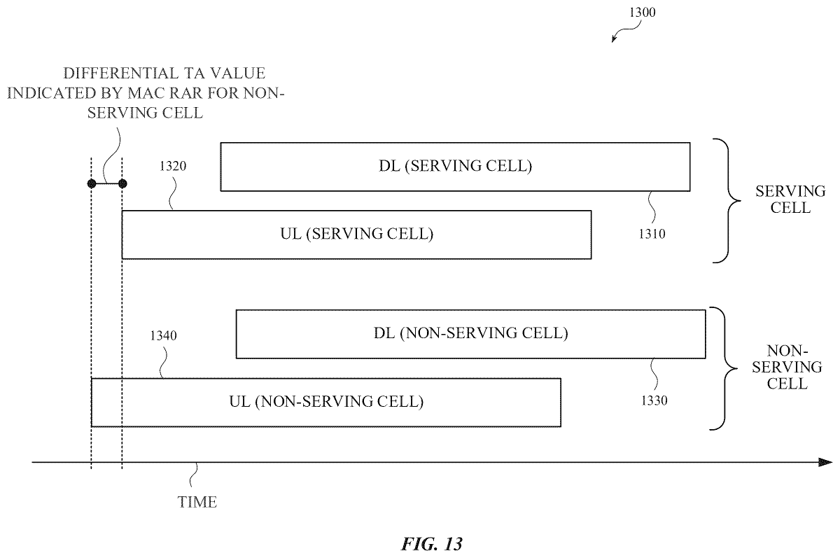

FIG. 13 is a diagram of an example 1300 of multi-TRP communications and a corresponding differential TA value, according to one or more implementations described herein. As shown, example 1300 may include DL and UL transmission periods 1310 and 1320 for a serving cell (e.g., base station 122-1) and DL and UL transmission periods 1330 and 1340 for a non-serving cell (e.g., base station 122-1). As shown, UE 110 may implement a time differential (e.g., a differential TA value) may be implemented between UL communications 1320 and 1340. In some implementations, the differential timing value may be provided to UE 110 via a MAC RAR message for the non-serving cell. As described above, depending on the implementation or scenario, the MAC RAR message may be provided by the serving cell or the non-serving cell. The differential TA value may be indicated by TA command (TAC) information in the MAC RAR message. In some implementations, the differential TA value be indicated as a differential TA value with a reference, or relative to, a TA value of serving cell. Providing a differential TA value as a relative value instead of a complete TA value may, for example, help minimize signaling overhead as a relative TA value may use fewer bits.

In some implementations, the network may explicitly indicate, to UE 110, one of the following TA values via RRC signaling (e.g., without involvement of an CFRA procedure or MAC RAR). TA=0 (e.g., no TA) may be used for an initial UL transmission to the non-serving cell (which may be used for scenarios involving small cells). Additionally, or alternatively, RRC signaling may explicitly indicate that UE 110 is to use the same TA for the non-serving cell as is being used for the serving cell. This TA instruction may be used for scenarios when UE 110 is located at or near a cell boundary between the serving cell and non-serving cell. Additionally, or alternatively, RRC signaling may explicitly indicate that UE 110 is to obtain UL timing information from the non-serving cell using a DL timing difference between the serving cell and non-serving cell. The DL timing difference may be determined as follows: T₂=T₁+Δ_{DL}, where T₁ and T₂ may be UL TA values of the serving cell (e.g., base station 122-1) and non-serving cell (e.g., base station 122-2), respectively, and where Δ_{DL} may be a DL timing difference between the serving cell and the non-serving cell, which may be measured at the UE side and may, or may not, be reported to network.

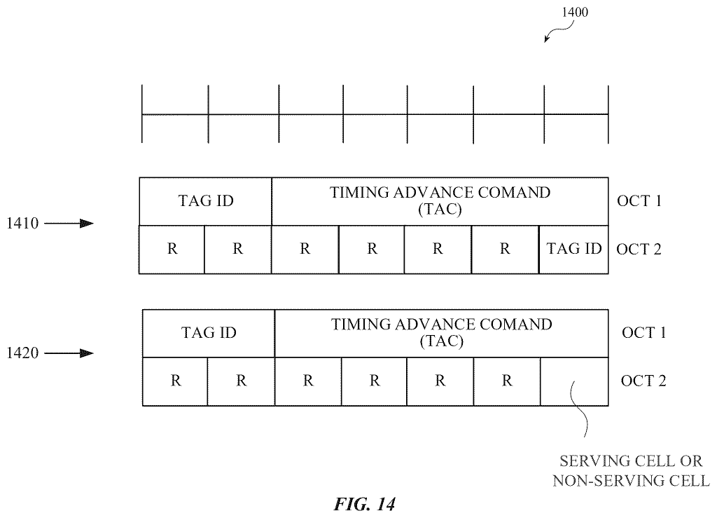

FIG. 14 is a diagram of examples 1400 of enhanced MAC CEs 1410 and 1420 according to one or more of the implementations described herein. Enhanced MAC CEs 1410 and 1420 may be configured to indicate a non-serving cell TRP (e.g., base station 122-2) TA valuc. As shown, enhanced MAC CEs 1410 and 1420 may each include a first and second octet (oct 1 and oct 2). Octet 1 may include two bits for a timing advance group (TAG) ID information and six bits for TAC information, octet 2 may include 7 reserved bits (R). Octet 2 of enhanced MAC CE 1410 may include a one-bit extension to the TAG ID information of octet 1 (for a total of 3 bits) to indicate a TAG ID for an intra-frequency serving cell, and octet 2 of enhanced MAC CE 1420 may include a one-bit indictor (for a total of 3 bits) to indicate a TAG ID for either an intra-frequency serving cell or an intra-frequency non-serving cell.

One or more of the techniques described herein may include one or more of a variety of approaches or solutions for maintaining multiple UL timings towards multiple, inter-cell TRPs with different PCIs. This may include scenarios where a single base station includes an antenna array capable of operating as multiple TRPs with different PCIs, and/or scenarios where multiple base stations provide service to a particular cell or coverage area and each base station functions as one or more TRPs with a different PCI. In such scenarios, separate TAGs (e.g., TAG IDs) may be assigned for serving cell(s) and non-serving cell(s).

In some implementations, a TAG ID associated with an intra-frequency, non-serving cell (e.g., base station 122-2) may be explicitly configured via RRC signaling by the serving cell (e.g., base station 122-1). The TAG ID of a non-serving cell may be provided after UE 110 performs a CFRA procedure and obtains an initial TA value (e.g., via a RAR message) for the non-serving cell. In other implementations, a TAG ID associated with an intra-frequency, non-serving cell (e.g., base station 122-2) may be implicitly determined by UE 110 based on the TAG ID of an intra-frequency serving cell (e.g., base station 122-1). A TAG ID for an intra-frequency, non-serving cell may be represented by a TAG_{nonServing} parameter. A TAG ID for an intra-frequency serving cell may be identified as a TAG_{Serving} parameter. A total number of TAGs of serving cells across a frequency (S) may be determined as follows: TAG_{nonServing}=TAG_{Serving}+S. For example, assuming two TAGs are configured for serving cells of the serving base station using TAG 0 and TAG 1. Then, the TAG ID ‘X’ for the intra-frequency non-serving cells on the same frequencies of serving cells in TAG 0 would be computed as X=0+2=2. Therefore, TAG 2 may be used for these non-serving cells for TA update. Similarly, TAG ID ‘Y’ for the intra-frequency non-serving cells that are on the same frequencies of the serving cells as TAG 1 would be computed as Y=1+2=3. Consequently, TAG 2 may be used for these non-serving cells for TA update.

In other implementations, 1-4 (or more) TAGs may be used for both intra-frequency and inter-frequency component carriers (CCs) for a given UE 110 such that the existing TAC MAC CE may be reused to update TA values. In other implementations, an enhanced TAC MAC CE may be used to extend a maximum TAG number from 4 to 8 (e.g., by adding an additional TAG ID bit as shown in enhanced MAC CE 1410 of FIG. 14). In such implementations, the enhanced TAC MAC CE may be identified by a MAC sub-header with a dedicated logical channel ID. In other implementations, an associated TAG may be implicitly indicated by a CORESET that includes scheduling DCI of a TAC MAC CE. An example of this is discussed below with reference to the following figure.

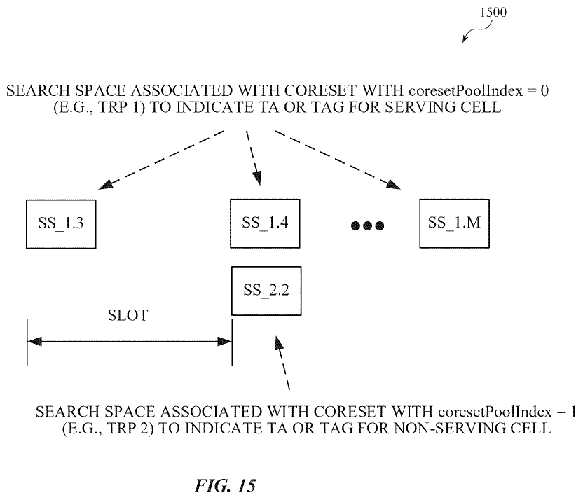

FIG. 15 is a diagram of an example 1500 of search spaces associated with CORESETs of different TRPs according to one or more implementations described herein. TRP 1 may correspond to base station 122-1, and TRP 2 may correspond to base statin 122-2. As shown, TRP 1 search spaces (SSs) with CORESETs (that include a coresetPoolIndex value of 0) may include search space SS_1.3 in a first slot, SS_1.4 in a second slot, . . . and so on until SS 1.M (where M is greater than or equal to 5). The second slot may also include SS_2.2 with a CORESET (that include a coresetPoolIndex value of 1) of TRP 2. SSs 1.3, 1.4, and 1.M may indicate a TA or a TAG for a serving cell TRP. SS 2.2 may indicate a TA or TAG for a non-serving cell. As such, when UE 110 receives DCI in a CORESET with a coresetPoolIndex value of 0, UE 110 may apply the TA and/or TAG to a serving cell. By contrast, when UE 110 receives DCI in a CORESET with a coresetPoolIndex value of 1, UE 110 may apply the TA and/or TAG to a non-serving cell.

Referring to FIG. 14, a single TAG maybe applied for intra-frequency serving cell and non-serving cell. In such implementations, two TA values may be separately indicated, per TAG, for a serving cell and a non-serving cell operating at a given frequency. Enhanced MAC CE 1420 of FIG. 14 may include an example of a MAC CE configured to indicate a single TAG ID and TA information (at octet 1) and to indicate whether the TAG ID and TA information applies to a serving cell or non-serving cell (at octet 2). As such, Enhanced MAC CE 1420 of FIG. 14 may enable the indication of two TA values per TAG ID (e.g., for whether the MAC CE corresponds to a serving cell or a non-serving cell). In some implementations, two TA values may be separately and implicitly indicated, per TAG, for a serving cell and a non-serving cell. For example, when UE 110 receives DCI in a CORESET with a coresetPoolIndex value of 0, UE 110 may apply the TA and/or TAG to a serving cell. By contrast, when UE 110 receives DCI in a CORESET with a coresetPoolIndex value of 1, UE 110 may apply the TA and/or TAG to a non-serving cell. Accordingly, the techniques described herein include a variety of approaches and solutions for maintaining UL timing (e.g., TA information) for multiple, inter-cell TRPs with different PCIs though use of TAGs.

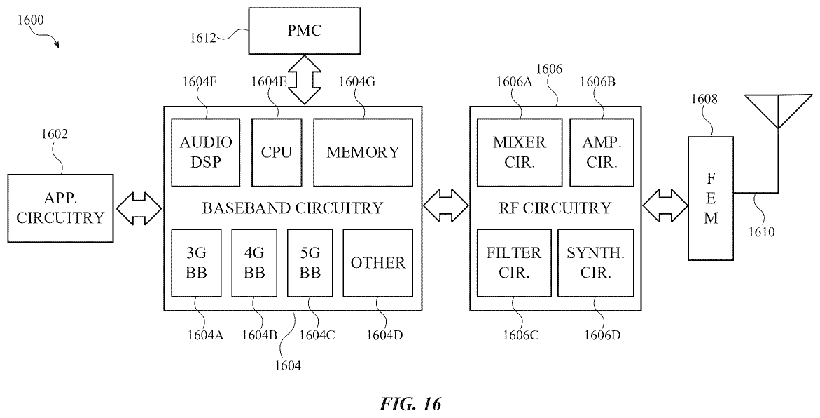

FIG. 16 is a diagram of an example of components of a device according to one or more implementations described herein. In some implementations, the device 1600 can include application circuitry 1602, baseband circuitry 1604, RF circuitry 1606, front-end module (FEM) circuitry 1608, one or more antennas 1610, and power management circuitry (PMC) 1612 coupled together at least as shown. The components of the illustrated device 1600 can be included in a UE or a RAN node. In some implementations, the device 1600 can include fewer clements (e.g., a RAN node may not utilize application circuitry 1602, and instead include a processor/controller to process IP data received from a CN such as 5GC 130 or an Evolved Packet Core (EPC)). In some implementations, the device 1600 can include additional elements such as, for example, memory/storage, display, camera, sensor (including one or more temperature sensors, such as a single temperature sensor, a plurality of temperature sensors at different locations in device 1600, etc.), or input/output (I/O) interface. In other implementations, the components described below can be included in more than one device (e.g., said circuitries can be separately included in more than one device for Cloud-RAN (C-RAN) implementations).

The components of the device of FIG. 16 may be configured and used to enable UEs 110 to perform on or more operations and/or procedures described herein. For example, components (e.g., processors, memory, and interfaces) of the device of FIG. 11 many enable UE 110 to communicate, to a serving base station 122, a reference signal received power (RSRP) measurement on a non-serving cell corresponding to a non-serving base station 122; receive instructions to perform a CFRA procedure towards the non-serving base station; communicate, in response to the instructions and to the non-serving base station, a random access (RA) preamble message that is configured for the CFRA procedure associated with the non-serving cell of the non-serving base station; and receive, from the non-serving base station and in response to the RA preamble message, a random access response (RAR) message that includes TA information for communicating on the non-serving cell.

The application circuitry 1602 can include one or more application processors. For example, the application circuitry 1602 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1600. In some implementations, processors of application circuitry 1602 can process IP data packets received from an EPC.

The baseband circuitry 1604 can include circuitry such as, but not limited to, one or more single-core or multi-core processors. The baseband circuitry 1604 can include one or more baseband processors or control logic to process baseband signals received from a receive signal path of the RF circuitry 1606 and to generate baseband signals for a transmit signal path of the RF circuitry 1606. Baseband circuity 1604 can interface with the application circuitry 1602 for generation and processing of the baseband signals and for controlling operations of the RF circuitry 1606. For example, in some implementations, the baseband circuitry 1604 can include a 3G baseband processor 1604A, a 4G baseband processor 1604B, a 5G baseband processor 1604C, or other baseband processor(s) 1604D for other existing generations, generations in development or to be developed in the future (e.g., 2G, 6G, etc.). The baseband circuitry 1604 (e.g., one or more of baseband processors 1604A-D) can handle various radio control functions that enable communication with one or more radio networks via the RF circuitry 1606. In other implementations, some or all of the functionality of baseband processors 1604A-D can be included in modules stored in the memory 1604G and executed via a Central Processing Unit (CPU) 1604E. The radio control functions can include, but are not limited to, signal modulation/demodulation, encoding/decoding, radio frequency shifting, etc. In some implementations, modulation/demodulation circuitry of the baseband circuitry 1604 can include Fast-Fourier Transform (FFT), precoding, or constellation mapping/de-mapping functionality. In some implementations, encoding/decoding circuitry of the baseband circuitry 1604 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, the baseband circuitry 1604 can include one or more audio digital signal processor(s) (DSP) 1604F. The audio DSPs 1604F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1604 and the application circuitry 1602 can be implemented together such as, for example, on a system on a chip (SOC).

In some implementations, the baseband circuitry 1604 can provide for communication compatible with one or more radio technologies. For example, in some implementations, the baseband circuitry 1604 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1604 is configured to support radio communications of more than one wireless protocol can be referred to as multi-mode baseband circuitry.

RF circuitry 1606 can enable communication with wireless networks using modulated electromagnetic radiation through a non-solid medium. In various implementations, the RF circuitry 1606 can include switches, filters, amplifiers, etc. to facilitate the communication with the wireless network. RF circuitry 1606 can include a receive signal path which can include circuitry to down-convert RF signals received from the FEM circuitry 1608 and provide baseband signals to the baseband circuitry 1604. RF circuitry 1606 can also include a transmit signal path which can include circuitry to up-convert baseband signals provided by the baseband circuitry 1604 and provide RF output signals to the FEM circuitry 1608 for transmission.

In some implementations, the receive signal path of the RF circuitry 1606 can include mixer circuitry 1606A, amplifier circuitry 1606B and filter circuitry 1606C. In some implementations, the transmit signal path of the RF circuitry 1606 can include filter circuitry 1606C and mixer circuitry 1606A. RF circuitry 1606 can also include synthesizer circuitry 1606D for synthesizing a frequency for use by the mixer circuitry 1606A of the receive signal path and the transmit signal path. In some implementations, the mixer circuitry 1606A of the receive signal path can be configured to down-convert RF signals received from the FEM circuitry 1608 based on the synthesized frequency provided by synthesizer circuitry 1606D. The amplifier circuitry 1606B can be configured to amplify the down-converted signals and the filter circuitry 1606C can be a low-pass filter (LPF) or band-pass filter (BPF) configured to remove unwanted signals from the down-converted signals to generate output baseband signals. Output baseband signals can be provided to the baseband circuitry 1604 for further processing. In some implementations, the output baseband signals can be zero-frequency baseband signals, although this is not a requirement. In some implementations, mixer circuitry 1606A of the receive signal path can comprise passive mixers, although the scope of the implementations is not limited in this respect.

In some implementations, the mixer circuitry 1606A of the transmit signal path can be configured to up-convert input baseband signals based on the synthesized frequency provided by the synthesizer circuitry 1606D to generate RF output signals for the FEM circuitry 1608. The baseband signals can be provided by the baseband circuitry 1604 and can be filtered by filter circuitry 1606C.

In some implementations, the mixer circuitry 1606A of the receive signal path and the mixer circuitry 1606A of the transmit signal path can include two or more mixers and can be arranged for quadrature down conversion and up conversion, respectively. In some implementations, the mixer circuitry 1606A of the receive signal path and the mixer circuitry 1606A of the transmit signal path can include two or more mixers and can be arranged for image rejection (e.g., Hartley image rejection). In some implementations, the mixer circuitry 1606A of the receive signal path and the mixer circuitry 906A can be arranged for direct down conversion and direct up conversion, respectively. In some implementations, the mixer circuitry 1606A of the receive signal path and the mixer circuitry 1606A of the transmit signal path can be configured for super-heterodyne operation.

In some implementations, the output baseband signals and the input baseband signals can be analog baseband signals, although the scope of the implementations is not limited in this respect. In some alternate implementations, the output baseband signals and the input baseband signals can be digital baseband signals. In these alternate implementations, the RF circuitry 1606 can include analog-to-digital converter (ADC) and digital-to-analog converter (DAC) circuitry and the baseband circuitry 1604 can include a digital baseband interface to communicate with the RF circuitry 1606.

In some dual-mode implementations, a separate radio IC circuitry can be provided for processing signals for each spectrum, although the scope of the implementations is not limited in this respect.

In some implementations, the synthesizer circuitry 1606D can be a fractional-N synthesizer or a fractional N/N+1 synthesizer, although the scope of the implementations is not limited in this respect as other types of frequency synthesizers can be suitable. For example, synthesizer circuitry 1606D can be a delta-sigma synthesizer, a frequency multiplier, or a synthesizer comprising a phase-locked loop with a frequency divider.

The synthesizer circuitry 1606D can be configured to synthesize an output frequency for use by the mixer circuitry 1606A of the RF circuitry 1606 based on a frequency input and a divider control input. In some implementations, the synthesizer circuitry 1606D can be a fractional N/N+1 synthesizer.

In some implementations, frequency input can be provided by a voltage controlled oscillator (VCO), although that is not a requirement. Divider control input can be provided by either the baseband circuitry 1604 or the applications circuitry 1602 depending on the desired output frequency. In some implementations, a divider control input (e.g., N) can be determined from a look-up table based on a channel indicated by the applications circuitry 1602.

Synthesizer circuitry 1606D of the RF circuitry 1606 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay clements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1606D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1606 can include an IQ/polar converter.

FEM circuitry 1608 can include a receive signal path which can include circuitry configured to operate on RF signals received from one or more antennas 1610, amplify the received signals and provide the amplified versions of the received signals to the RF circuitry 1606 for further processing. FEM circuitry 1608 can also include a transmit signal path which can include circuitry configured to amplify signals for transmission provided by the RF circuitry 1606 for transmission by one or more of the one or more antennas 1610. In various implementations, the amplification through the transmit or receive signal paths can be done solely in the RF circuitry 1606, solely in the FEM circuitry 1608, or in both the RF circuitry 1606 and the FEM circuitry 1608.

In some implementations, the FEM circuitry 1608 can include a Tx/Rx switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1606). The transmit signal path of the FEM circuitry 1608 can include a power amplifier (PA) to amplify input RF signals (e.g., provided by RF circuitry 1606), and one or more filters to generate RF signals for subsequent transmission (e.g., by one or more of the one or more antennas 1610).

In some implementations, the PMC 1612 can manage power provided to the baseband circuitry 1604. In particular, the PMC 1612 can control power-source selection, voltage scaling, battery charging, or DC-to-DC conversion. The PMC 1612 can often be included when the device 1600 is capable of being powered by a battery, for example, when the device is included in a UE. The PMC 1612 can increase the power conversion efficiency while providing desirable implementation size and heat dissipation characteristics.

While FIG. 16 shows the PMC 1612 coupled only with the baseband circuitry 1604. However, in other implementations, the PMC 1612 may be additionally or alternatively coupled with, and perform similar power management operations for, other components such as, but not limited to, application circuitry 1602, RF circuitry 1606, or FEM circuitry 1608.

In some implementations, the PMC 1612 can control, or otherwise be part of, various power saving mechanisms of the device 1600. For example, if the device 1600 is in an RRC_Connected state, where it is still connected to the RAN node as it expects to receive traffic shortly, then it can enter a state known as Discontinuous Reception Mode (DRX) after a period of inactivity. During this state, the device 1600 can power down for brief intervals of time and thus save power.

If there is no data traffic activity for an extended period of time, then the device 1600 can transition off to an RRC_Idle state, where it disconnects from the network and does not perform operations such as channel quality feedback, handover, etc. The device 1600 goes into a very low power state and it performs paging where again it periodically wakes up to listen to the network and then powers down again. The device 1600 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 1602 and processors of the baseband circuitry 1604 can be used to execute elements of one or more instances of a protocol stack. For example, processors of the baseband circuitry 1604, alone or in combination, can be used execute Layer 3, Layer 2, or Layer 1 functionality, while processors of the baseband circuitry 1604 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

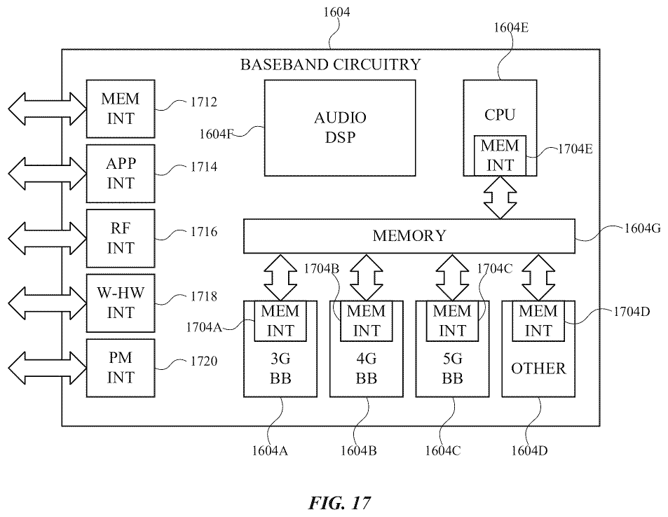

FIG. 17 is a diagram of example interfaces of baseband circuitry according to one or more implementations described herein. As discussed above, the baseband circuitry 1604 of FIG. 16 can comprise processors 1604A-E and a memory 1604G utilized by said processors. Each of the processors 1604A-E can include a memory interface, 1704A-E, respectively, to send/receive data to/from the memory 1604G.

UEs 110 may use one or more components of FIG. 17 to perform one or more operations for processes described herein. For example, UE 110 may use one or more processors 1604A-1604E, memory interfaces 1704A-1704Es, and memory 1604G, etc., to: communicate, to a serving base station 122, a reference signal received power (RSRP) measurement on a non-serving cell corresponding to a non-serving base station 122; receive instructions to perform a CFRA procedure towards the non-serving base station; communicate, in response to the instructions and to the non-serving base station, a random access (RA) preamble message that is configured for the CFRA procedure associated with the non-serving cell of the non-serving base station; and receive, from the non-serving base station and in response to the RA preamble message, a random access response (RAR) message that includes TA information for communicating on the non-serving cell.

The baseband circuitry 1604 can further include one or more interfaces to communicatively couple to other circuitries/devices, such as a memory interface 1712 (e.g., an interface to send/receive data to/from memory external to the baseband circuitry 1604), an application circuitry interface 1714 (e.g., an interface to send/receive data to/from the application circuitry 1602 of FIG. 16), an RF circuitry interface 1716 (e.g., an interface to send/receive data to/from RF circuitry 1606 of FIG. 16), a wireless hardware connectivity interface 1718 (e.g., an interface to send/receive data to/from Near Field Communication (NFC) components, Bluetooth® components (e.g., Bluetooth® Low Energy), Wi-Fi® components, and other communication components), and a power management interface 1709 (e.g., an interface to send/receive power or control signals to/from the PMC 1612).

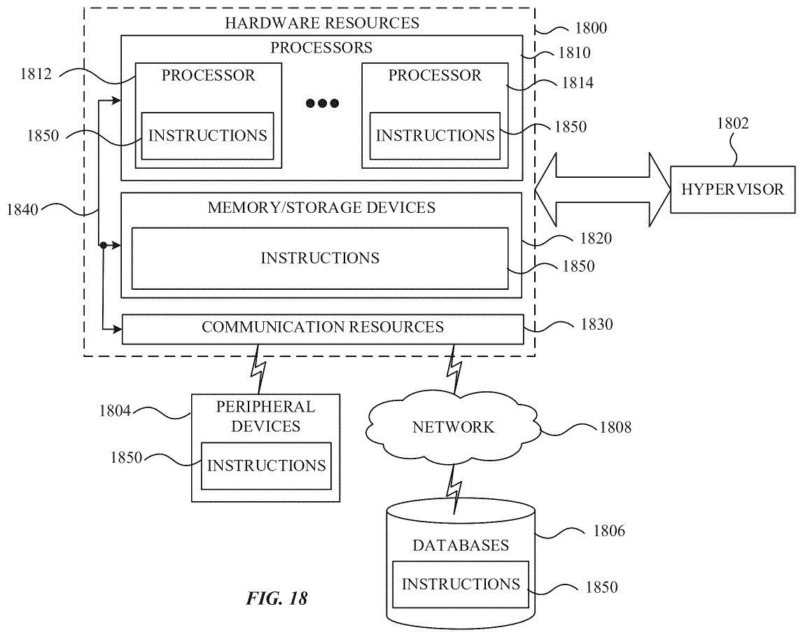

FIG. 18 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 18 shows a diagrammatic representation of hardware resources 1800 including one or more processors (or processor cores) 1810, one or more memory/storage devices 1820, and one or more communication resources 1830, each of which may be communicatively coupled via a bus 1840. For embodiments where node virtualization (e.g., NFV) is utilized, a hypervisor 1802 may be executed to provide an execution environment for one or more network slices/sub-slices to utilize the hardware resources 1800

UEs 110 and base station 122 may use one or more components of FIG. 18 to perform one or more operations for processes described herein. For example, processors 1810, instructions 1850, memory/storage device 1820, and communication resources 1830 may be used to: enable UE to: communicate, to a serving base station 122, a reference signal received power (RSRP) measurement on a non-serving cell corresponding to a non-serving base station 122; receive instructions to perform a CFRA procedure towards the non-serving base station; communicate, in response to the instructions and to the non-serving base station, a random access (RA) preamble message that is configured for the CFRA procedure associated with the non-serving cell of the non-serving base station; and receive, from the non-serving base station and in response to the RA preamble message, a random access response (RAR) message that includes TA information for communicating on the non-serving cell.

The processors 1810 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1812 and a processor 1814.

The memory/storage devices 1820 may include main memory, disk storage, or any suitable combination thereof. The memory/storage devices 1820 may include, but are not limited to any type of volatile or non-volatile memory such as dynamic random-access memory (DRAM), static random-access memory (SRAM), crasable programmable read-only memory (EPROM), electrically erasable programmable read-only memory (EEPROM), Flash memory, solid-state storage, etc.

The communication resources 1830 may include interconnection or network interface components or other suitable devices to communicate with one or more peripheral devices 1804 or one or more databases 1806 via a network 1808. For example, the communication resources 1830 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1850 may comprise software, a program, an application, an applet, an app, or other executable code for causing at least any of the processors 1810 to perform any one or more of the methodologies discussed herein. The instructions 1850 may reside, completely or partially, within at least one of the processors 1810 (e.g., within the processor's cache memory), the memory/storage devices 1820, or any suitable combination thereof. Furthermore, any portion of the instructions 1850 may be transferred to the hardware resources 1800 from any combination of the peripheral devices 1804 or the databases 1806. Accordingly, the memory of processors 1810, the memory/storage devices 1820, the peripheral devices 1804, and the databases 1806 are examples of computer-readable and machine-readable media.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a baseband processor of a user equipment (UE) may comprise: one or more processors configured to: communicate, to a serving base station, a reference signal received power (RSRP) measurement on a non-serving cell corresponding to a non-serving base station; receive instructions to perform a contention free random access (CFRA) procedure towards a non-serving base station; communicate, in response to the instructions and to the non-serving base station, a random access (RA) preamble message that is configured for the CFRA procedure associated with the non-serving cell of the non-serving base station; and receive, from the non-serving base station and in response to the RA preamble message, a random access response (RAR) message that includes timing advance (TA) information for communicating on the non-serving cell.

In example 2, which may also include one or more of the examples described herein, the instructions are received via a search space (SS) associated with non-serving cell. In example 3, which may also include one or more of the examples described herein, the one or more processors is further configured to: communicate, to the serving base station and in response to the RAR message, an indication of a successful completion of the CFRA procedure to the non-serving cell. In example 4, which may also include one or more of the examples described herein, the instructions include a downlink (DL) control information (DCI) received from the non-serving base station. In example 5, which may also include one or more of the examples described herein, the DCI is received in response to the RSRP measurement being forwarded by the serving base station to the non-serving base station.

In example 6, which may also include one or more of the examples described herein, the instructions include DCI received from the serving base station. In example 7, which may also include one or more of the examples described herein, the DCI is transmitted in a control resource set (CORESET) that is configured with a coresetPoolIndex value associated with the non-serving cell of non-serving base station. In example 8, which may also include one or more of the examples described herein, the DCI includes a target cell ID (TCI) of the non-serving cell of non-serving base station. In example 9, which may also include one or more of the examples described herein, the DCI includes a physical cell ID (PCI) of the non-serving cell.

In example 10, which may also include one or more of the examples described herein, radio resource control (RRC) signaling is used to provide a dedicated target cell ID (TCI) value for a non-serving cell with a physical cell ID (PCI) and the DCI is used to indicate a TCI value to the UE for performing the CFRA procedure towards the non-serving cell of non-serving base station that is associated with the TCI value. In example 11, which may also include one or more of the examples described herein, the instructions comprise a medium control access (MAC) control element (CE) that activates at least one transmission configuration indicator state for PDSCH of a non-serving cell. In example 12, which may also include one or more of the examples described herein, the instructions comprise radio resource control (RRC) signaling to provide dedicated physical random access channel (PRACH) resources for each SSB of the non-serving cell and a medium control access (MAC) control clement (CE) is used to trigger the CFRA procedure and corresponding PRACH transmission towards the non-serving cell.

In example 13, which may also include one or more of the examples described herein, a baseband processor of a user equipment (UE) may comprise: one or more processors configured to: communicate, to a serving base station, a reference signal received power (RSRP) measurement on a non-serving cell corresponding to a non-serving base station; receive, from the serving base station and in response to the RSRP measurement, dedicated random access channel (RACH) resources corresponding to the non-serving cell of the non-serving base station; monitor at least one condition for performing a contention free random access (CFRA) procedure towards the non-serving base station; when the at least one condition is satisfied, communicate a random access (RA) preamble message that is configured for the CFRA procedure on the non-serving cell of the non-serving base station; and receive, from the non-serving base station and in response to the RA preamble message, a random access response (RAR) message that includes timing advance (TA) information for communicating on the non-serving cell of with the non-serving base station.

In example 14, which may also include one or more of the examples described herein, the dedicate RACH resource is provided to be associated with a system synchronization block (SSB) of a channel status information (CSI) reference signal (RS) (CSI-RS) of the non-serving cell of the non-serving base station. In example 15, which may also include one or more of the examples described herein, a rsrp-ThresholdSSB or rsrp-ThresholdCSI-RS, regarding the non-serving cell, is configured and used to determine whether the at least one condition of the CFRA procedure is satisfied. In example 16, which may also include one or more of the examples described herein, the RSRP measurement based on the SSB or CSI-RS transmitted on the non-serving cell is used to determine whether the condition is satisfied by comparing the RSRP measurement with the rsrp-ThresholdSSB or rsrp-ThresholdCSI-RS.

In example 17, which may also include one or more of the examples described herein, a baseband processor of a user equipment (UE) may comprise: one or more processors configured to: communicate, to a serving base station, a reference signal received power (RSRP) measurement on a non-serving cell corresponding to a non-serving base station; communicate, to a non-serving base station, a random access (RA) preamble message that is configured for a contention free random access (CFRA) procedure associated with the non-serving cell of the non-serving base station; and receive, from the non-serving base station and in response to the RA preamble message, a random access response (RAR) message that includes timing advance (TA) information for communicating on the non-serving cell of the non-serving base station.

In example 18, which may also include one or more of the examples described herein, a type 1 (Type 1) physical downlink control channel (PDCCH) common search space (CSS) (Type1-PDCCH CSS) on the non-serving cell of the non-serving base station is monitored to receive the RAR message from the non-serving base station. In example 19, which may also include one or more of the examples described herein, a configuration of the Type1-PDCCH CSS of the non-serving cell is received from the serving cell of the serving base station prior to the UE communicating the RA preamble message. In example 20, which may also include one or more of the examples described herein, a configuration of the Type1-PDCCH CSS of the non-serving cell is determined based on a configuration of a Type1-PDCCH CSS of the serving cell.

In example 21, which may also include one or more of the examples described herein, a Type1-PDCCH CSS of the serving cell is monitored to receive the RAR message that is associated with the RA preamble message transmitted towards the non-serving cell. In example 22, which may also include one or more of the examples described herein, the TA information includes a differential TA value of the non-serving cell relative to a TA value of the serving cell of the serving base station. In example 23, which may also include one or more of the examples described herein, the serving cell of the serving base station and non-serving cell of the non-serving base station correspond to different timing advance groups (TAGs).

In example 24, which may also include one or more of the examples described herein, a TAG ID of the non-serving cell of the non-serving base station is explicitly configured by the serving base station via radio resource control (RRC) signaling. In example 25, which may also include one or more of the examples described herein, a TAG ID of the non-serving cell of the non-serving base station is implicitly determined by the UE based on a TAG ID of the serving cell of the serving base station and a total number of TAGs of servicing cells of the serving base station across a particular frequency. In example 26, which may also include one or more of the examples described herein, a number of TAGs configured for non-serving cells and serving cells is limited to up to 4. In example 27, which may also include one or more of the examples described herein, the TA information is provided via a timing advance command (TAC) media access control (MAC) control element (CE) comprising a 3-bit TAG ID field. In example 28, which may also include one or more of the examples described herein, a cell between a serving cell and a corresponding non-serving cell to apply the TA information is explicitly indicated by a 1-bit field in MAC-CE.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A baseband processor of a user equipment (UE), comprising:
one or more processors configured to:
communicate, to a serving base station, a reference signal received power (RSRP) measurement on a non-serving cell corresponding to a non-serving base station;
receive instructions to perform a contention free random access (CFRA) procedure towards the non-serving base station;
communicate, in response to the instructions and to the non-serving base station, a random access (RA) preamble message that is configured for the CFRA procedure associated with the non-serving cell of the non-serving base station; and
receive, from the non-serving base station and in response to the RA preamble message, a random access response (RAR) message that includes timing advance (TA) information for communicating on the non-serving cell.

2. The baseband processor of claim 1, wherein the one or more processors are configured to generate UE capability information indicating a maximum number of additional PCIs per frequency for obtaining the TA information.

3. The baseband processor of claim 1, wherein the one or more processors is further configured to:
communicate, to the serving base station and in response to the RAR message, an indication of a successful completion of the CFRA procedure to the non-serving cell.

4. The baseband processor of claim 1,
wherein the instructions include a downlink (DL) control information (DCI) received from the non-serving base station, and
wherein the DCI is received in response to the RSRP measurement being forwarded by the serving base station to the non-serving base station.

5. (canceled)

6. The baseband processor of claim 1,
wherein the instructions include a downlink (DL) control information (DCI) transmitted in a control resource set (CORESET) that is configured with a coresetPoolIndex value associated with the non-serving cell of non-serving base station.

7. (canceled)

8. The baseband processor of claim 6, wherein the DCI includes a target cell ID (TCI) field indicating a physical cell ID (PCI) of the non-serving cell of non-serving base station.

9. The baseband processor of claim 6, wherein the DCI includes a physical cell ID (PCI) of the non-serving cell.

10. (canceled)

11. The baseband processor of claim 1, wherein the instructions comprise a medium control access (MAC) control element (CE) that activates at least one transmission configuration indicator state for PDSCH of a non-serving cell.

12. The baseband processor of claim 1, wherein the instructions comprise radio resource control (RRC) signaling to provide dedicated physical random access channel (PRACH) resources for each SSB of the non-serving cell and a medium control access (MAC) control element (CE) is used to trigger the CFRA procedure and corresponding PRACH transmission towards the non-serving cell.

13. A baseband processor of a user equipment (UE), comprising:
one or more processors configured to:
communicate, to a serving base station, a reference signal received power (RSRP) measurement on a non-serving cell corresponding to a non-serving base station;
receive, from the serving base station and in response to the RSRP measurement, dedicated random access channel (RACH) resources corresponding to the non-serving cell of the non-serving base station;
monitor at least one condition for performing a contention free random access (CFRA) procedure towards the non-serving base station;
when the at least one condition is satisfied, communicate a random access (RA) preamble message that is configured for the CFRA procedure on the non-serving cell of the non-serving base station; and
receive, from the non-serving base station and in response to the RA preamble message, a random access response (RAR) message that includes timing advance (TA) information for communicating on the non-serving cell of with the non-serving base station.

14. The baseband processor of claim 13, wherein the dedicate RACH resource is provided to be associated with a system synchronization block (SSB) of a channel status information (CSI) reference signal (RS) (CSI-RS) of the non-serving cell of the non-serving base station.

15. The baseband processor of claim 14, wherein a rsrp-ThresholdSSB or rsrp-ThresholdCSI-RS, regarding the non-serving cell, is configured and used to determine whether the at least one condition of the CFRA procedure is satisfied.

16. (canceled)

17. A baseband processor of a user equipment (UE), comprising:
one or more processors configured to:
communicate, to a serving base station, a reference signal received power (RSRP) measurement on a non-serving cell corresponding to a non-serving base station;
communicate, to a non-serving base station, a random access (RA) preamble message that is configured for a contention free random access (CFRA) procedure associated with the non-serving cell of the non-serving base station; and
receive, from the non-serving base station and in response to the RA preamble message, a random access response (RAR) message that includes timing advance (TA) information for communicating on the non-serving cell of the non-serving base station.

18-21. (canceled)

22. The baseband processor of claim 17, wherein the TA information includes a differential TA value of the non-serving cell relative to a TA value of the serving cell of the serving base station.

23. The baseband processor of claim 22, wherein the serving cell of the serving base station and non-serving cell of the non-serving base station correspond to different timing advance groups (TAGs).

24. The baseband processor of claim 23, wherein a TAG ID of the non-serving cell of the non-serving base station is explicitly configured by the serving base station via radio resource control (RRC) signaling.

25. The baseband processor of claim 23, wherein a TAG ID of the non-serving cell of the non-serving base station is implicitly determined by the UE based on a TAG ID of the serving cell of the serving base station and a total number of TAGS of servicing cells of the serving base station across a particular frequency.

26. The baseband processor of claim 23, wherein a number of TAGs configured for non-serving cells and serving cells is limited to up to 4.

27. The baseband processor of claim 23, wherein the TA information is provided via a timing advance command (TAC) media access control (MAC) control element (CE) comprising a 3-bit TAG ID field.

28. The baseband processor of claim 23, wherein a cell between a serving cell and a corresponding non-serving cell to apply the TA information is explicitly indicated by a 1-bit field in MAC-CE.
